(19) United States
(12) Patent Application Publication
(10) Pub. No.: US 2014/0342318 A1
(43) Pub. Date: Nov. 20, 2014

(54) Device and Method for Treating Oral Pigmentation

(71) Applicant: Pranadent LLC, Calabasas, CA (US)

(72) Inventor: Rashad Riman, Beverly Hills, CA (US)

(73) Assignee: Pranadent LLC, Calabasas, CA (US)

(21) Appl. No.: 14/250,333

(22) Filed: Apr. 10, 2014

Related U.S. Application Data
(60) Provisional application No. 61/824,014, filed on May 16, 2013.

(51) Int. Cl. A61C 19/08

(52) U.S. Cl. CPC A61C 19/08
USPC 433/215

(57) ABSTRACT

A method is disclosed. The method discloses applying an anesthetic to at least a portion of a surface of an area in a patient's mouth affected by a gingiva pigmentation, and applying a pressurized fluid to the at least the portion of the surface.

### CROSS REFERENCE TO RELATED APPLICATIONS

This application claims the benefit of U.S. Provisional Application No. 61/824,014, filed on May 16, 2013, which is incorporated herein by reference in its entirety.

### FIELD

The present invention relates to treating oral pigmentation.

### BACKGROUND

Referring to FIG. 1, gingiva 110 is a soft tissue lining of the mouth 100. The gingiva, commonly referred to as “gums,” 110 surrounds teeth 115 and provides a seal around them as well as covers the jaw bone. Referring to FIGS. 1 and 2, the gingiva 110 is divided into four anatomical areas: a) Free gingiva 120; b) Gingiva sulcus 125; c) Interdental gingiva 130; and d) Attached gingiva 140.

Referring to FIG. 3, the gingiva 110 is composed of an outer epithelium layer 175 and an underlying core of connective tissue 170 above bone 171. The epithelium layer 175 is composed of a Stratum Corneum layer 145, Stratum Lucidum layer 150, Stratum Granulosum layer 155, Stratum Spinosum layer 160 and Stratum Basale layer 165.

The color of the epithelium layer 175 is determined by number and size of blood vessels, oxygenation of blood, thickness of the epithelium layer 175, and/or amount of pigment in the epithelium layer 175.

As known in the art, melanin plays a significant role in the color of the epithelium layer 175. Melanocytes residing in the Stratum Basale layer 165 convert tyrosine (an amino acid) to melanin using the enzyme tyrosinase. Melanin is then stored in the cells of the Stratum Basale layer 165 in the form of a melanosome. Melanosome can also be found in keratinocytes which are located at the most superficial layer of the gingiva 110.

The intensity of pigmentation is influenced, for example, by physical, chemical and/or hormonal factors. Chemical factors may include long-term use of the antibiotic minocycline, anti-malaria medications and/or tri-cyclic antidepressants. Certain conditions/diseases may also cause oral pigmentation. For example, Addison's disease; Hemochromatosis; Peutz Jeghers syndrome; Albright's syndrome; Neurofibromatosis; smoking; secondary smoking; and/or alcoholism may cause dark pigmentation of the epithelium layer 175. Gingival pigmentation is also influenced by genetics and is predominantly seen in people of African, East Asian, Mediterranean, Hispanic and other ethnic background.

Although pigmentation in the gingiva 110 is not a medical problem, people with moderate to severe gingiva pigmentation desire cosmetic therapy. Several treatments currently exist. For example, certain treatments utilize blades and/or diamond burs to surgically remove pigmentation. This is a very invasive, imprecise and painful process and can cause exposed bone, gum recession and excessive tissue thinning Certain treatments utilize chemicals (90% phenol and 95% alcohol) to remove the pigmentation. This is also very harmful and toxic to the gingiva. Certain treatments utilize extreme cold (i.e. liquid nitrogen) to remove pigmentation. These cryosurgical treatments are done in segments, create tissue sloughing by design, can affect non-pigmented areas, do not provide penetration depth control, do not allow the doctor to observe the changes immediately after the procedure, and may cause a bone necrosis and sequestrum after the procedure. Certain treatments use lasers to remove pigmentation. One of the most commonly used laser device is the Diode laser which is heat producing with potential to cause tissue damage. Lasers can also cause gum recession, damage to underlying bone, are not efficient at the gingiva margin and interdental area/papilla area due to risk of tissue loss. Laser equipment is also very costly and not always affordable by doctors world-wide.

In most of the currently known treatments, re-pigmentation has been reported 1-30 months after the treatment. This may occur when melanocytes from adjacent tissues migrate to the treated area.

In view of the limitations and risks of the known treatments, an improved a method and device are presently described for removing gingiva pigmentation.

### BRIEF DESCRIPTION OF THE FIGURES

FIGS. 1-3 depict portions of patient's oral cavity as known in the art.

FIG. 4 depicts an embodiment according to the present disclosure.

FIG. 5 depicts another embodiment according to the present disclosure.

FIGS. 6a-e depict embodiments of nozzles according to the present disclosure.

FIG. 7 depicts a process according to the present disclosure.

FIG. 8 depicts another process according to the present disclosure.

FIG. 9 depicts another process according to the present disclosure.

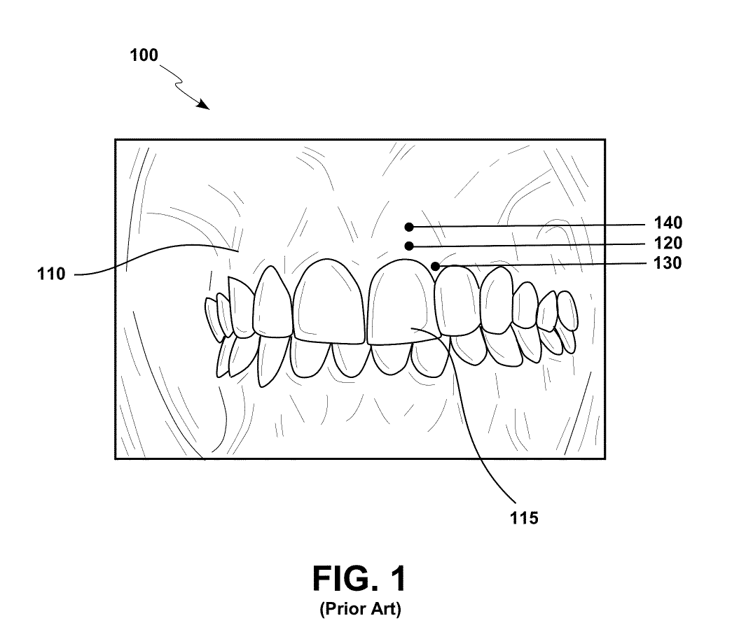

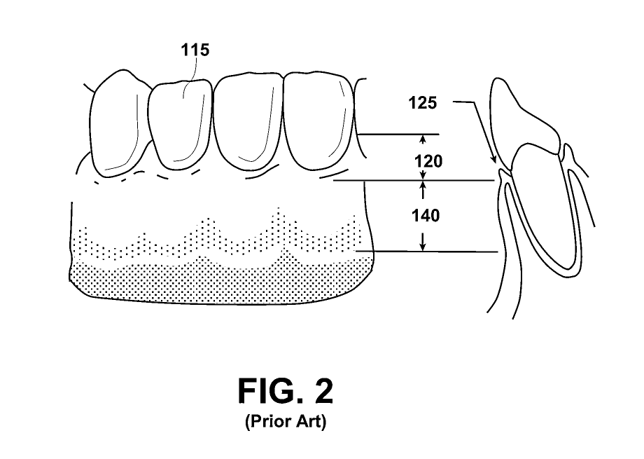

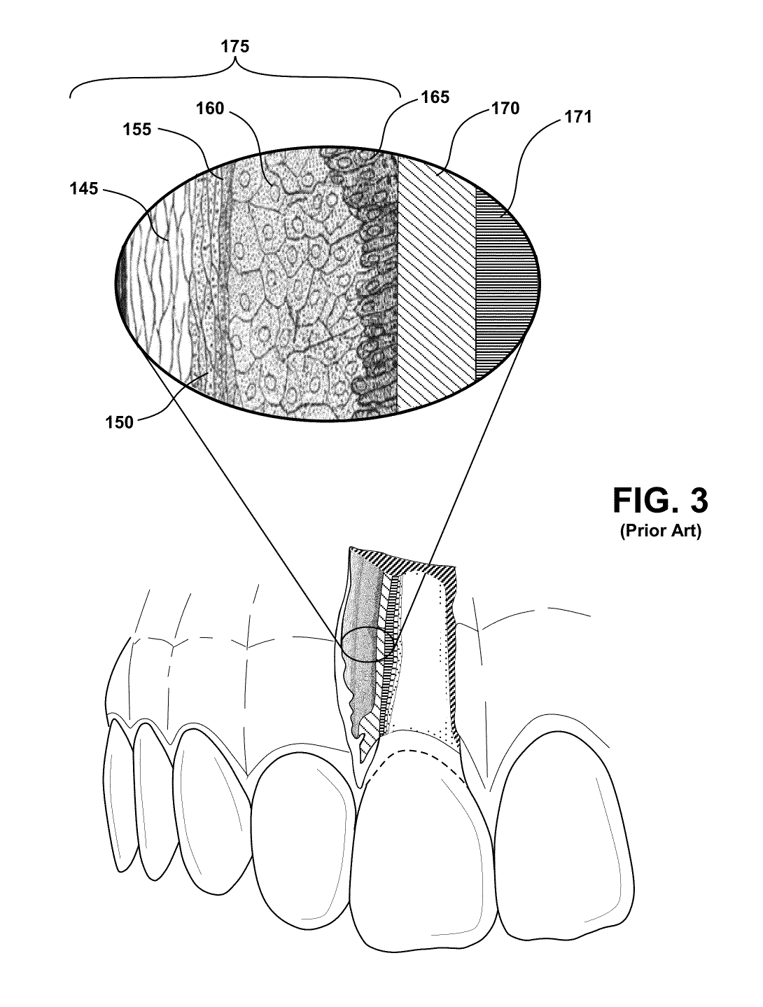

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

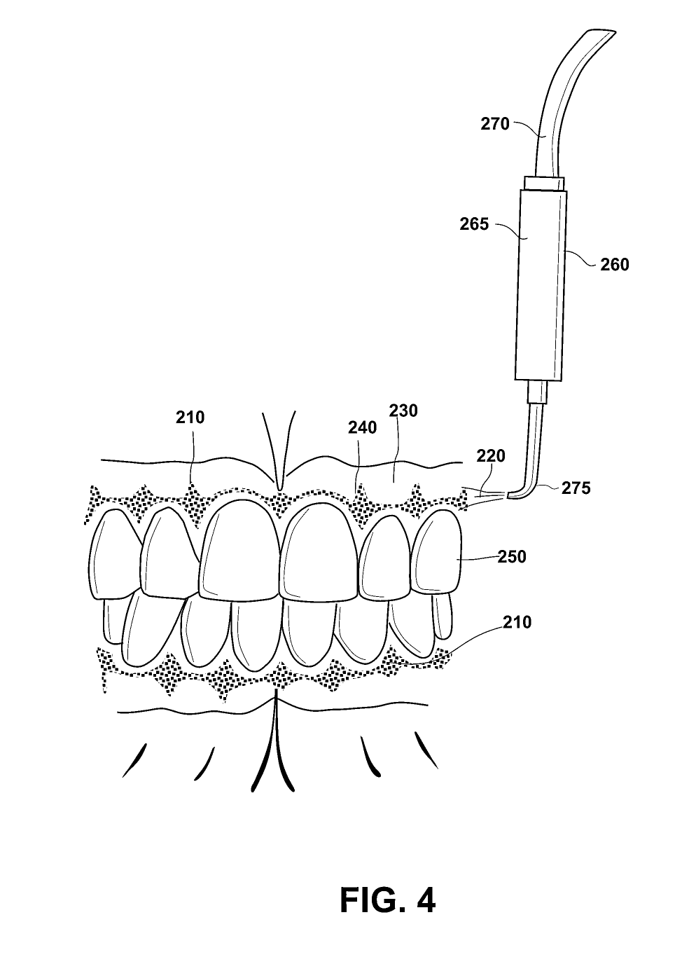

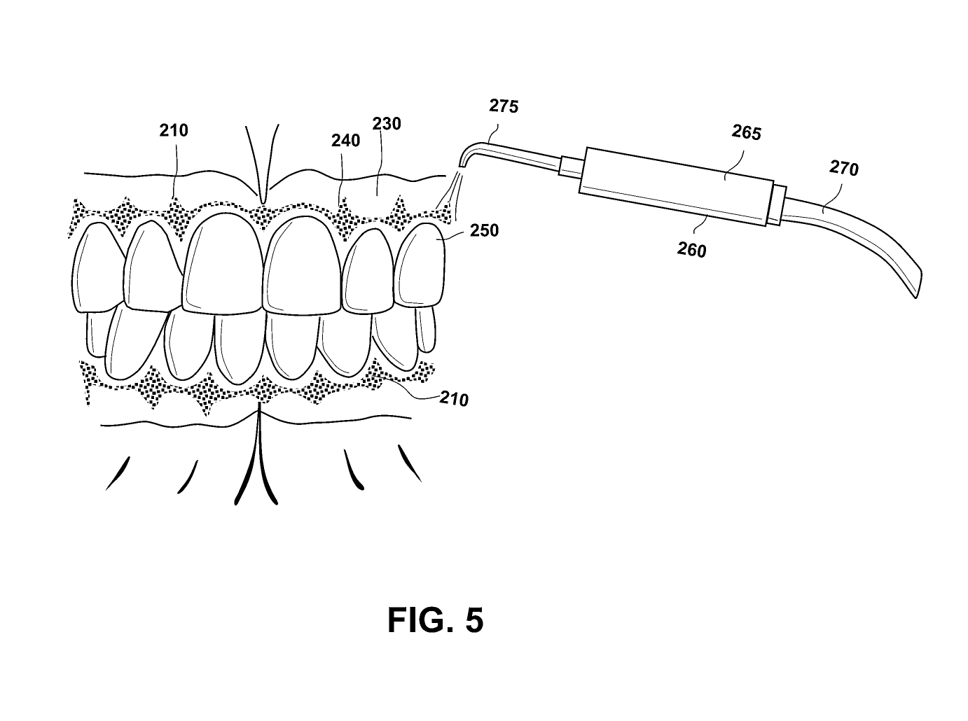

Referring to FIGS. 4-5, in some embodiments presently disclosed, gingiva pigmentation 210 is removed by applying pressurized fluid 220 on the gingiva 230 and removing at least a portion of an epithelium layer 240 associated with the gingiva pigmentation 210. In some embodiments, the pressurized fluid 220 comprises air, water, gas, liquid, mixture of gasses, and/or mixture of liquids appropriate for human use. In some embodiments, the pressurized fluid 220 comprises powder abrasive particles mixed with a liquid appropriate for human use. In some embodiments, the powder abrasive particles comprise sodium bicarbonate or aluminum trihydroxide (ATH) that have been rendered to a powder. In some embodiments, the powder abrasive particles range <1 μm to 100 μm in diameter. In some embodiments, the powder abrasive particles are coated with and/or mixed with anti-bacterial medication to minimize healing time and any possible infections. In some embodiments, the powder abrasive particles comprise ice particles, wherein the ice particles are particles of frozen water and/or other liquids. In some embodiments, the liquid is air, water, gas, and/or a mixture of different types of gasses.

In some embodiments, to avoid tissue emphysema, the pressurized fluid 220 is applied substantially perpendicular to the surface of the gingiva 230 as shown in FIG. 4. In some embodiments, to avoid tissue emphysema, the pressurized fluid 220 is applied at an angle to the surface of the gingiva 220 and away from the roots of the teeth 250 and their overlying mucosa as shown in FIG. 5.

In some embodiments, the pressurized fluid 220 is applied through a fluid-delivery device 260. The fluid-delivery device 260 comprises a body 265 and/or handle (not shown) designed to be gripped by the hand of an operator or a robotic device during the medical procedure of removing the gingiva pigmentation 210. In some embodiments, the fluid-delivery device 260 may be coupled to a fluid-storage device (not shown) through one or more flexible tubes 270. In some embodiments, the fluid-delivery device 260 comprises one or more controls (not shown) for controlling the pressure of the pressurized fluid 220 and/or the amount of powder abrasive particles within the liquid. In some embodiments, the fluid-storage device (not shown) comprises one or more controls (not shown) for controlling the pressure of the pressurized fluid 220 and/or the amount of powder abrasive particles within the liquid.

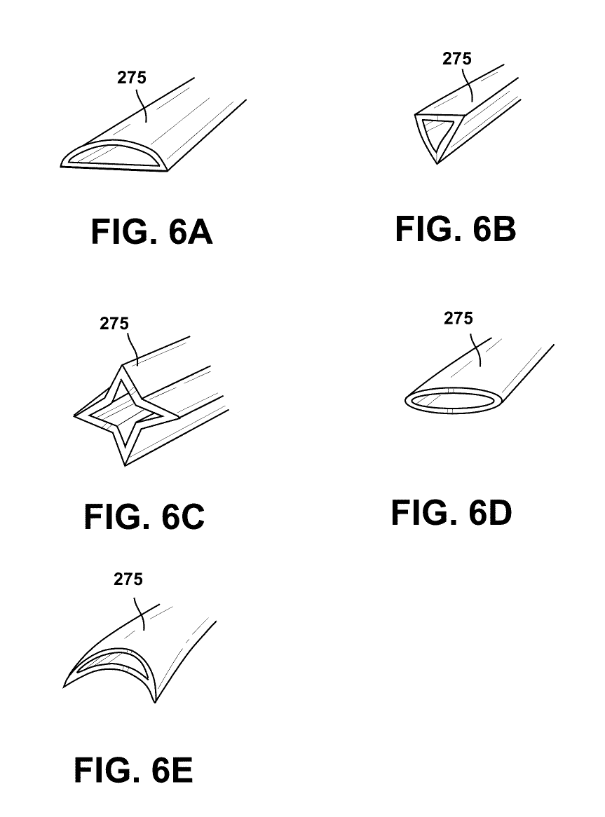

In some embodiments, the fluid-delivery device 260 delivers the pressurized fluid 220 through a nozzle 275. Although the cross-section of the nozzle 275 is depicted as substantially circular (as shown in FIGS. 4 and 5), it is to be understood that the nozzle 275 may, for example, comprise a semi-circular cross-section as shown in FIG. 6a, a triangular cross-section as shown in FIG. 6b, a star shaped cross-section as shown in FIG. 6c, an ovoid cross-section as shown in FIG. 6d, a U-shaped cross section as shown in FIG. 6e or any other shaped cross-section that would allow the operator to focus the pressurized fluid 220 in an accurate manner and achieve safe, effective removal of the gingiva pigmentation 210 with minimum damage to the surrounding, non-pigmented tissues.

In some embodiments, the triangular cross-shaped nozzle 275 shown in FIG. 6b may be used to remove the gingiva pigmentation 210 located between the teeth 250. In some embodiments, the semicircular cross-shaped nozzle 275 shown in FIG. 6a and/or U-shaped cross-shaped nozzle 275 shown in FIG. 6e may be used to remove the gingiva pigmentation 210 located above the teeth 250.

In some embodiments, the nozzle 275 is held about 0.5 mm to 4 mm from the gingiva pigmentation 210 while being moved back and forth above the gingiva pigmentation 210 to prevent tissue damage and uneven tissue removal. In some embodiments, the tip of the nozzle 275 is held against the gingiva pigmentation 210 while being moved back and forth above the gingiva pigmentation 210 to prevent tissue damage and uneven tissue removal. In some embodiments, the nozzle 275 is held about 1 mm from the gingiva pigmentation 210. In some embodiments, the operator of the device 260 determines and at least partially adjusts the distance of the nozzle 275 to the gingiva pigmentation 210 throughout the procedure.

In some embodiments, when the pressurized fluid 220 is water or another liquid, it is administered at a pressure of about 14 psig to about 145 psig (i.e. 95-1000 kPa). In some embodiments, when the pressurized fluid 220 is air or other gases, it is administered at pressures of about 65 psig to about 120 psig (i.e. 448-827 kPa). In some embodiments, the flow rate of the pressurized fluid 220 is less than 60 ml/min.

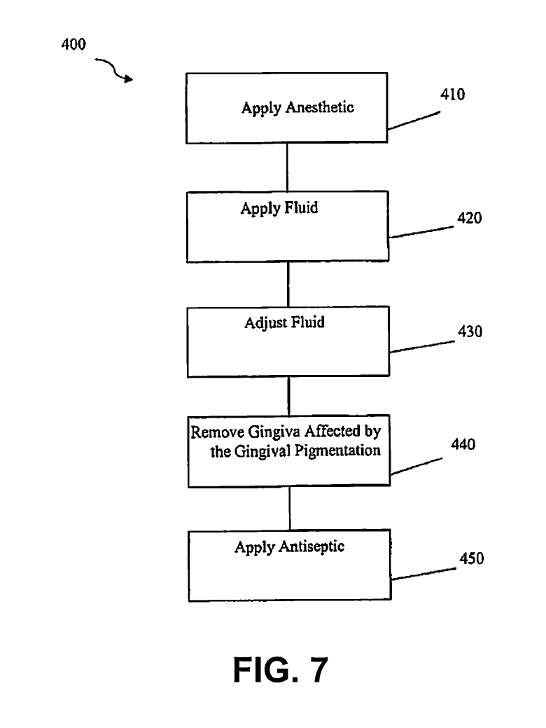

In one embodiment, a process 400 for removing the gingiva pigmentation according to the present disclosure is shown in FIG. 7. At 410, an anesthetic is applied to an area affected by a gingiva pigmentation. In some embodiment, the anesthetic is local. In some embodiment, the anesthetic is topical. In some embodiment, the anesthetic is epinephrine 2% (1:100,000 epinephrine) or any other anesthetic that is safe for the patient as determined by the operator/medical professional. At 420, a pressurized fluid 220 is applied to the area affected by the gingiva pigmentation. At 430, pressurized fluid 220's pressure and/or amount of particles in the fluid is gradually adjusted until gingiva tissue affected by the gingiva pigmentation begins to peel off. In some embodiments, the fluid's pressure, amount of particles, and/or size of the particles in the fluid sufficient to remove gingiva tissue affected by the gingiva pigmentation depends on the thickness and/or denseness of the patient's gingiva. At 440, the adjusted pressurized fluid 220 is used to remove gingiva tissue affected by the gingiva pigmentation. In some embodiments, the adjusted pressurized fluid is applied until the exposed tissue is red and no more pigmentation is visible. At 450, an oral antiseptic solution is applied to the exposed tissue to prevent infection and/or enhance the healing process.

In some embodiments, the process 400 may further comprise applying wax to protect patient's teeth; providing glasses to protect patient's eyes; providing one or more gauze to protect patient's mucosa and/or to control bleeding; providing suction to prevent the fluid and/or particles from accumulating in the patient's mouth; periodically applying sterile saline to irrigated the exposed tissue and remove residual particles; applying additional local anesthesia to control bleeding; applying pressure and/or hemostatic agents as necessary to control bleeding; and/or applying anti-oxidant gel or other medication that enhance healing.

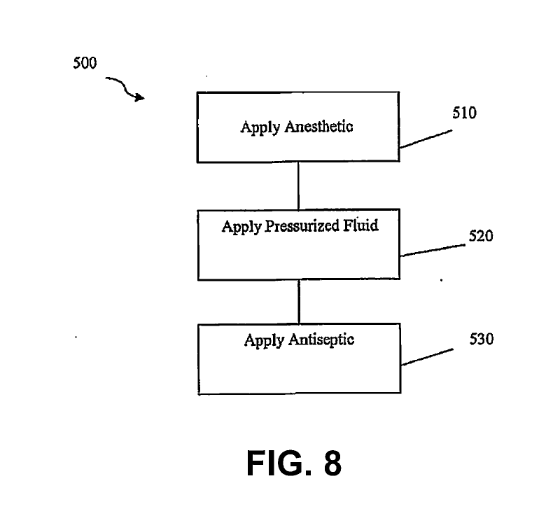

In one embodiment, a process 500 for removing the gingiva pigmentation according to the present disclosure is shown in FIG. 8. At 510, an anesthetic is applied to an area affected by a gingiva pigmentation. In some embodiment, the anesthetic is local. In some embodiment, the anesthetic is topical. At 520, a pressurized fluid 220 is applied to the area affected by the gingiva pigmentation. In some embodiments, the pressurized fluid 220 is applied until the exposed tissue is red and no more pigmentation is visible. In some embodiments, the pressurized fluid 220 comprises liquid. In some embodiments, the pressurized fluid 220 comprises liquid and particles. At 530, an oral antiseptic solution may be optionally applied to the exposed tissue to prevent infection and/or enhance the healing process.

In some embodiments, the process 500 may further comprise applying wax to protect patient's teeth; providing glasses to protect patient's eyes; providing one or more gauze to protect patient's mucosa and/or to control bleeding; providing suction to prevent the fluid from accumulating in patient's mouth; periodically applying sterile saline to irrigated the exposed tissue and remove residual particles; applying additional local anesthesia to control bleeding; applying pressure and/or hemostatic agents as necessary to control bleeding; and/or applying anti-oxidant gel or other medication that enhance healing.

Although pigmentation can occur in gingiva as described above, it can also occur in buccal mucosa (the inside of the cheek, not shown), lips (not shown), palate (not shown) and/or tongue (not shown). It is to be understood that the embodiments presently described may be used to treat any oral pigmentation.

Although the above description discloses removal of gingiva pigmentation, it is to be understood that the presently disclosed embodiments can also be applied to reduce tissue thickness in the oral cavity and/or to reduce scar tissue in the oral cavity.

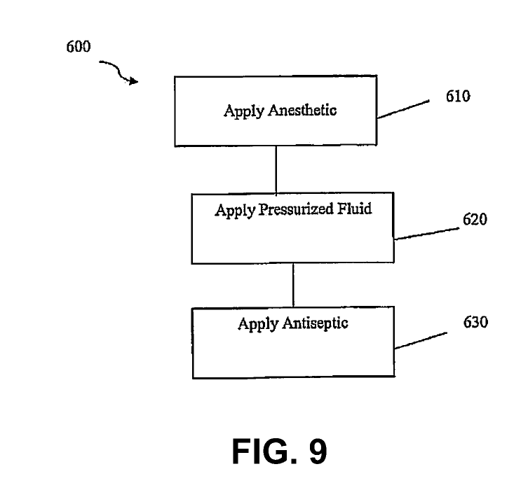

In one embodiment, a process 600 for reducing tissue thickness in the oral cavity and/or for reducing scar tissue in the oral cavity according to the present disclosure is shown in FIG. 9. At 610, an anesthetic is applied to an area with scarred and/or thick tissue. In some embodiment, the anesthetic is local. In some embodiment, the anesthetic is topical. At 620, a pressurized fluid 220 is applied to the area with scarred and/or thick tissue. In some embodiments, the pressurized fluid 220 is applied until the exposed tissue is red and/or a superficial layer(s) is removed. In some embodiments, the pressurized fluid 220 comprises liquid as described above. In some embodiments, the pressurized fluid 220 comprises liquid and particles as described above. At 630, an oral antiseptic solution may be optionally applied to the exposed tissue to prevent infection and/or enhance the healing process.

Although the pressurized fluid 220 as described above has been applied to polish/clean teeth, prior art does not teach, disclose or suggest applying the pressurized fluid 220 to remove gingiva pigmentation, to reduce tissue thickness and/or to reduce scar tissue in the oral cavity. As evident by the following studies, prior art clearly and specifically teaches against applying the pressurized fluid 220 to gum tissue. A study, by Hunter K M, Holborow D W, Kardos T B, Lee-Knight C T, Ferguson M M, titled “Bacteraemia and tissue damage resulting from air polishing”, published in Br Dent J. 1989 Oct. 21; 167(8):275-8, investigated the production of bacteraemia (entry of oral bacteria into the blood stream) in dental prophylaxis by use of a commercially available air polishing device. This study showed that air polishing can result in loss of epithelium at the gingival margin.

A clinical trial, ran by Mishkin D J, Engler W O, Saved T, Darby T D, Cobb R L, Coffman M A, titled “A clinical comparison of the effect on the gingiva of the Prophy-Jet and the rubber cup and paste techniques”, published in J. Periodontal. 1986 March; 57(3):151-4, compared the effect on the gingiva of the Prophy-Jet and the rubber cup and paste techniques of stain and supragingival plaque removal. This clinical trial showed that the Prophy-Jet caused a statistically significant increase (P less than 0.05) in gingival irritation immediately posttreatment.

A study, by Vande Velde F, Adriaens P, De Boever J, titled “Clinical, histological and scanning electron microscopy evaluation of the Prophy-Jet in vivo and in vitro”, published in Rev Beige Med Dent. 1982 July; 37(4):153-7, showed that air polishing causes gum desquamation and aphtous ulcers. The study further concluded that the negative aspects of the use of the Prophy-Jet are very important and therefore should be used with caution.

A study, by Tapia J L, Neiders M E, Aguirre A, McCall WD Jr, Cohen R E, titled “Inflammatory response to dental polishing and prophylaxis materials in rats”, published in J Int Acad Periodontol. 2011 October; 13(3):86-92, showed that air polishing powder can cause a mild inflammatory response in the gum tissue.

A study, by Kontturi-Närhi V, et al, titled “The gingival effects of dental airpolishing as evaluated by scanning electron microscopy”, published in J. Periodontol. 1989 January; 60(1):19-22, showed that air polishing caused dental gum bleeding and erosive changes. This study further concluded that negative aspects of air polishing should be considered when operating next to the gum.

Similarly to the studies referred to above, machines configured to dispense pressurized fluid 220 as known in the art and the abrasive particles/powder that are dispensed by these machines come with the following warning: “Do not direct the air polishing stream at soft tissue or into the sulcus. Tissue emphysema has been reportedly caused when the air/water/powder stream was directed at the soft tissues or into the sulcus.”

According to one aspect, a method is presently disclosed. The method comprising applying an anesthetic to at least a portion of a surface of an area in a patient's mouth affected by a gingiva pigmentation and applying a pressurized fluid to the at least the portion of the surface.

In view of the studies referred to above and the warnings included with the machines/powder, it is clear that the presently disclosed embodiments are novel and non-obvious in view of the prior art.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . .”

What is claimed is:

1. A method comprising:
applying an anesthetic to at least a portion of a surface of an area in a patient's mouth affected by a gingiva pigmentation; and
applying a pressurized fluid to the at least the portion of the surface.

2. The method of claim 1, further comprising applying antiseptic solution to the at least the portion of the surface exposed to pressurized fluid.

3. The method of claim 1, wherein the pressurized fluid comprises liquid.

4. The method of claim 3, wherein the pressurized fluid further comprises a plurality of abrasive particles.

5. The method of claim 1, wherein the pressurized fluid comprises water.

6. The method of claim 5, wherein the pressurized fluid further comprises a plurality of abrasive particles.

7. The method of claim 1, wherein the pressurized fluid comprises gas.

8. The method of claim 7, wherein the pressurized fluid further comprises a plurality of abrasive particles.

9. The method of claim 1, wherein the pressurized fluid comprises mixture of gasses.

10. The method of claim 9, wherein the pressurized fluid further comprises a plurality of abrasive particles.

11. The method of claim 1, wherein the pressurized fluid comprises mixture of liquids.

12. The method of claim 11, wherein the pressurized fluid further comprises a plurality of abrasive particles.

13. The method of claim 1, wherein the pressurized fluid comprises a plurality of abrasive particles.

14. The method of claim 13, wherein the plurality of abrasive particles comprise sodium bicarbonate or aluminum trihydroxide.

15. The method of claim 13, wherein the plurality of abrasive particles are at least partially coated with anti-bacterial medication

16. The method of claim 13, wherein the plurality of abrasive particles comprise frozen liquid.

17. The method of claim 1, wherein applying a pressurized fluid to at least the portion of the surface comprises applying the pressurized fluid at an angle to at least the portion of the surface.

18. The method of claim 1, wherein applying a pressurized fluid to at least the portion of the surface comprises applying the pressurized fluid in a direction towards patient's teeth.

19. The method of claim 1, wherein applying a pressurized fluid to at least the portion of the surface comprises applying the pressurized fluid substantially perpendicular to at least the portion of the surface.

20. The method of claim 1, wherein the local anesthetic is applied topically to the at least the portion of the surface.

21. The method of claim 1, wherein the local anesthetic is epinephrine.

22. The method of claim 1, wherein applying a pressurized fluid to at least the portion of the surface comprises adjusting pressure of the pressurized fluid until the at least the portion of the surface begins to peel off.
